(19) United States
(12) Patent Application Publication
(10) Pub. No.: US 2022/0235219 A1
(43) Pub. Date: Jul. 28, 2022

(54) RESIN COMPOSITION, USE OF THE RESIN COMPOSITION, OPTOELECTRONIC DEVICE AND METHOD FOR PRODUCING AN OPTOELECTRONIC DEVICE

(71) Applicant: OSRAM Opto Semiconductors GmbH, Regensburg (DE)

(72) Inventors: Klaus HOEHN, Forchheim (DE); Christina KEITH, Neutraubling (DE)

(21) Appl. No.: 17/606,943

(22) PCT Filed: May 5, 2020
(86) PCT No.: PCT/EP2020/062423

§ 371 Date: Oct. 27, 2021

(30) Foreign Application Priority Data
May 9, 2019 (DE) 10 2019 112 143.4

(51) Int. Cl. C08L 63/00

(52) U.S. Cl. CPC C08L 63/00

(57) ABSTRACT

A resin composition is provided which contains a mixture comprising a cycloaliphatic epoxy resin, a coupling agent, and an epoxy-containing compound, and/or a polycarbonate alcohol. Further, the resin composition contains a hardener component comprising a dicarboxylic anhydride, a dicarboxylic anhydride semi ester, an organic phosphite and an accelerator.

A resin composition, a use of the resin composition, an optoelectronic device and a method of manufacturing an optoelectronic device are disclosed.

In the industrial manufacture of optoelectronic devices, such as LEDs (light emitting diodes) and modules, epoxy resin compounds or silicones are used as mounting and housing materials, as casting resins and as matrix material for optical functions or as lens material. With increasing brightness and higher temperatures during manufacture and operation of the devices, their ageing and yellowing stability reaches the limits of use.

Cycloaliphatic epoxy resins known to date and used as casting resins have the particular disadvantages that they are not sufficiently stable during their processing, are mechanically insufficiently stable in the target applications and can lead to cracks in the component and are often classified as hazardous to health.

One task to be solved is to specify a resin composition with a mixture based on an epoxy resin with improved properties. These and other tasks are achieved, inter alia, by a resin composition, a use of the resin composition, an optoelectronic device, and a method of manufacturing an optoelectronic device according to the independent claims.

Further embodiments are subject matter of the dependent claims.

A resin composition is disclosed which comprises a mixture comprising a cycloaliphatic epoxy resin, a coupling agent and an epoxy-containing compound, and/or a polycarbonate alcohol.

A mixture is to be understood in particular as a mixture comprising at least a cycloaliphatic epoxy resin, a coupling agent and an epoxy-containing compound, or a cycloaliphatic epoxy resin, a coupling agent and a polycarbonate alcohol, or a cycloaliphatic epoxy resin, a coupling agent, an epoxy-containing compound and a polycarbonate alcohol.

In this context, the term cycloaliphatic epoxy resin particularly means a monomer which can polymerise. The cycloaliphatic epoxy resin has at least two epoxy groups and at least one cycloaliphatic structural element. A cycloaliphatic structural element is to be understood in particular as cyclic structural elements based on hydrocarbons, which may in principle be saturated or unsaturated. For example, the cycloaliphatic structural element may be a cycloalkane, such as a C5 to C10 cycloalkane, for example cyclohexane. For example, at least one of the epoxide groups of the monomer may have two carbon atoms in common with two carbon atoms of the cycloaliphatic structural element.

According to at least one embodiment, the cycloaliphatic epoxy resin has at least one structural element of the following formula:

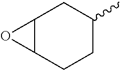

Here and in the following [symbol] stands for a bonding site within the cycloaliphatic epoxy resin. Preferably, the cycloaliphatic epoxy resin has at least two or exactly two structural elements of the formula just mentioned.

According to at least one embodiment, the cycloaliphatic epoxy resin comprises at least one carbalkoxy group (carboxylic ester group).

According to at least one embodiment, the at least two or exactly two structural elements of the aforementioned embodiment are linked to one another by a further structural element comprising a carbalkoxy group.

According to at least one preferred embodiment, the cycloaliphatic epoxy resin is a bis(epoxycyclohexyl)methyl carboxylate, in particular 3,4-epoxycyclohexylmethyl-3′,4′-epoxycyclohexanecarboxylate having the formula:

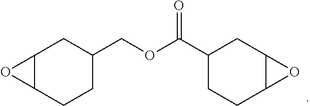 [SMILES: O=C(OCC1CCC2OC2C1)C1CCC2OC2C1]

3,4-Epoxycyclohexylmethyl-3′,4′-epoxycyclohexanecarboxylate (CAS 2386-87-0) is commercially available and thus easily accessible (e.g. as CY179-1CH or as Celloxide 2021 P). Such a cycloaliphatic epoxy resin is transparent and allows sufficient yellowing stability. Thus, it is well suited for use in optoelectronic devices.

According to at least one embodiment of the mixture, the proportion of the cycloaliphatic epoxy resin relative to the total weight of the mixture is between 50% by weight inclusive and 97% by weight inclusive, in particular between 80% by weight inclusive and 97% by weight inclusive.

The presence of the coupling agent in the mixture results in the resin composition containing the mixture and a functional material obtained by curing the resin composition having a particularly strong adhesion strength on the surface on which the resin composition is placed. In particular, the coupling agent enables improved adhesion at elevated temperatures, for example at 150° C. This is of particular advantage when used in electronic or optoelectronic components, as the component has good stability even when manufactured, assembled or applied in this temperature range, since the resin composition or the functional material does not peel off.

The epoxy-containing compound and/or the polycarbonate alcohol further contained in the mixture can at least partially react with the cycloaliphatic epoxy resin during curing of the resin composition and thus become part of the functional material which may be formed from the resin composition.

The epoxy-containing compound may also be designated herein and hereinafter as a reactive diluent. The reactive diluent may be a mono- or multi-functional aliphatic or cycloaliphatic epoxy resin and may, for example, reduce the viscosity of the mixture. Furthermore, for example, less hard functional materials with adjusted glass transition temperature Tg and tailored thermomechanical properties can be obtained from the mixture.

Examples of reactive diluents are dodecyl- and tetradecyl-glycidyl ether (CAS 68609-97-2), 2-ethylhexyl glycidyl ether (CAS 2461-15-6), C8-C10 glycidyl ether (CAS 68609-96-1) as well as aliphatic C6-C22 glycidyl ethers and glycidyl esters, which should have a low intrinsic colour according to APHA of max. 30 for optical applications. Also conceivable are flexibilised cycloaliphatic epoxy resins, for example CELLOXIDE 2081 from DAICEL:

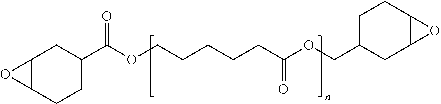

with a mean value of n=1.

According to at least one embodiment, the proportion of reactive diluent in the mixture relative to the total weight of the mixture is between 0% by weight inclusive and 20% by weight inclusive, in particular between 1% by weight inclusive and 10% by weight inclusive.

According to at least one embodiment, the proportion of the polycarbonate alcohol in the mixture, based on the total weight of the mixture, is between including 0% by weight and including 20% by weight, in particular between including 1% by weight and including 10% by weight.

Mixtures of reactive diluent and polycarbonate alcohol may also be present in the mixture.

According to one embodiment, the hardener component comprises at least one dicarboxylic anhydride and at least one dicarboxylic anhydride semi ester. The dicarboxylic anhydride may be selected, for example, from a group comprising hexahydrophthalic anhydride (HHPA), methyl hexahydrophthalic anhydride (MHHPA) and mixtures thereof. The dicarboxylic anhydride semi ester may be, for example, a semi ester of these compounds. The dicarboxylic anhydride may be present in the hardener component in an amount of from 70% by weight, inclusive, to 90% by weight, inclusive, based on the total weight of the hardener component, the dicarboxylic anhydride semi ester may be present in an amount of from 5% by weight, inclusive, to 30% by weight, inclusive, based on the total weight of the hardener component.

According to a further embodiment, the hardener component comprises an organic phosphite and an accelerator. The accelerator, in combination with the anhydride, can prevent yellowing of the resin composition or the functional material obtained therefrom, particularly in optical applications.

As an organic phosphite, for example, Irgafos TPP (triphenyl phosphite, CAS 101-02-0) can be used. Also conceivable is Irgafos DDPP (CAS 26544-23-0) and Irgafos TNPP (CAS 2623-78-4). The organic phosphite may be present in a proportion of from 1% by weight, inclusive, up to 10% by weight, inclusive, based on the total weight of the hardener component.

According to at least one embodiment, there is disclosed a resin composition comprising a mixture comprising a cycloaliphatic epoxy resin, a coupling agent, and an epoxy-containing compound and/or a polycarbonate-alcohol, and a hardener component comprising a dicarboxylic anhydride, a dicarboxylic anhydride semi ester, an organic phosphite and an accelerator.

The inventors have recognized that by adding the epoxy-containing compound and/or the polycarbonate alcohol to the mixture, a resin composition can be provided which has a long service life and a sufficiently low viscosity and can thus be readily utilised in, for example, LED manufacturing.

In such a resin composition, the mixture has good compatibility with the hardener component. The resin composition can be processed very well and has a stable, well detectable glass transition temperature (Tg), in particular a Tg of greater than 150° C. after thermal curing, which, in particular, changes only insignificantly by DSC measurement during the process time. This enables good process control during processing of the resin composition via the glass transition temperature, since the resin composition is sufficiently stable over the process time. Furthermore, the resin composition can be used to produce a functional material that is mechanically stable in its target application and does not lead to cracks. This can also be achieved without or with only a small addition of fillers in the resin composition. Thus, the resin composition has sufficient brightness and transparency and can be processed at lower cost and higher throughput. In addition, the resin composition can be used to produce a functional material that is particularly stable with respect to temperature and yellowing. These properties make the resin composition particularly suitable for its use in the manufacture of optoelectronic components.

According to at least one embodiment, the cycloaliphatic epoxy resin is free of aromatic structural units. Thus, it is a cycloaliphatic epoxy resin which contains only saturated hydrocarbon-based structural elements. Thus, a functional material made from the mixture is more stable to yellowing under thermal and photochemical stress, for example in the operation of an optoelectronic device. In addition, cycloaliphatic epoxy resins, which are free of aromatic structural units, are less harmful to health than, for example, mixtures of cycloaliphatic epoxy resins and bisphenol-A-diglycidyl ethers used to date.

According to a further embodiment, the coupling agent comprises an alkoxysilane. In particular, the coupling agent may comprise an alkoxysilane having at least one epoxy group. Further conceivable are alkoxysilanes with carboxy or alcohol groups.

According to a further embodiment, the coupling agent is present in the mixture in a proportion of from 0.2% by weight, inclusive, to 5% by weight, inclusive, based on the total weight of the mixture, in particular from 0.5% by weight, inclusive, to 2% by weight, inclusive.

According to a further embodiment, the alkoxysilane is a γ-glycidoxypropyltrimethoxysilane. In particular, due to the presence of the epoxy group, this enables a particularly good adhesion to a surface of the resin composition and thus of a functional material obtained therefrom.

According to a further embodiment, the polycarbonate alcohol comprises at least one carbonate structure. The polycarbonate alcohol may further comprise an alcohol ether having at least one carbonate structure. Carbonate structures may reduce the brittleness of a functional material obtained from the resin composition by curing, thereby improving the susceptibility of the functional material to cracking and crazing.

According to a further embodiment, the polycarbonate alcohol is a polycarbonate diol.

According to a further embodiment, the polycarbonate diol has the general formula

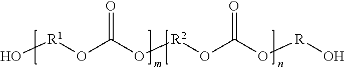

wherein R═R¹ or ═R² and wherein R, R¹ and R² are independently selected from a group comprising C1 to C22 alkyl groups.

Preferred polycarbonate alcohols should be readily processable and soluble in the mixture at a temperature up to 100° C. Particularly preferred are polycarbonate alcohols which are liquid at room temperature and have a low intrinsic colour according to APHA of max.30.

According to a further embodiment, the mixture further comprises at least one additive selected from a group comprising polyvalent alcohols, deaerators, degassing agents, leveling aids, release agents, brighteners, dyes, stabilizers, antioxidants, light stabilizers, fillers, pigments, thickeners, phosphors and mixtures thereof.

Polyvalent alcohols may include, for example, 1,2-propanediol, butanediol or trimethylpropanediol. They may be present individually or in combination in the mixture.

They provide further flexibility of the mixture when used in the resin composition. The proportion of polyvalent alcohols in the mixture relative to the total weight of the mixture may be between 0% by weight and 10% by weight inclusive, in particular between 0% by weight and 5% by weight inclusive.

Deaerators and degassing agents may be, for example, esters and organofluorine compounds. Deaerators and degassing agents can ensure that the resin composition containing the mixture does not develop bubbles during curing or that these are removed from the material.

Deaerators and degassing agents may each be present in a proportion of from 0% by weight to 2% by weight inclusive, in particular from 0% by weight to 1% by weight inclusive, based on the total weight of the mixture. For example, as deaerator or degassing agent BYK-A506 (BYK GmbH) can be used in a proportion of up to 0.5% by weight, in particular in optical resins.

Leveling aids can be, for example, esters, fluoroorganic compounds or acrylates. They can improve the wetting properties and the flow behaviour of the resin composition in which the mixture is used. Leveling aids may be present in a proportion of from 0% by weight to 2% by weight, inclusive, in particular from 0% by weight to 1% by weight, inclusive, based on the total weight of the mixture. For example, BYK-358N (BYK GmbH) may be added at a proportion of up to 0.5% by weight, particularly in optical resins.

Release agents can be understood as, for example, long-chain carboxylic acids with 12 to 22 carbon atoms. They may be beneficial to the casting properties of the resin composition containing the mixture. Release agents may be present in a proportion of from 0% by weight to inclusive 2% by weight, in particular 0% by weight up to and including 1% by weight, based on the total weight of the mixture. For example, Tegopren 5863 (Evonik Goldschmidt GmbH) with polyether-modified polysiloxanes as active substance can be used in particular in optical applications.

Brighteners or dyes can be, for example, anthraquinone dyes, which can be present in a proportion of 0% by weight up to and including 5% by weight, in particular 0% by weight up to and including 0.2% by weight, based on the total weight of the mixture. They may change the optical appearance of the resin composition in which the mixture is used, for example from blue to yellow.

Stabilizers, antioxidants and light stabilizers can be, for example, tris(2,4-di-tert-butylphenyl)phosphite (Irgafos 168, CAS 31570-04-4), pentaerythritol tetrakis[3-[3,5-di-tert-butyl-4-hydroxyphenyl]propionate (Irganox 1010, CAS 6683-19-8) or 1,3-di-tert-butyl-4-hydroxyphenol. They can improve the ageing behaviour of the resin composition in which the mixture is present. Furthermore, they may be present in a proportion of from 0% by weight to 5% by weight inclusive, in particular 0% by weight to 2% by weight, inclusive, based on the total weight of the mixture.

Fillers and pigments may be, for example, calcium fluoride, titanium dioxide, aluminum oxide, mica, silicon dioxide, wollastonite or calcium carbonate. They may be present in a proportion of from 0% by weight to 50% by weight inclusive, in particular 0% by weight to 30% by weight inclusive, based on the total weight of the mixture, and may influence properties of the functional material produced with the mixture, for example the reflectivity, the casting stability or the optical appearance.

As thickening agents, for example, pyrogenic silicas such as Aerosil R202 or Aerosil 200 can be used. They can be present in a proportion of 0% by weight up to and including 10% by weight, in particular 0% by weight up to and including 5% by weight, based on the total weight of the mixture.

Phosphors can be conventional phosphors which are used in LEDs for light conversion and, depending on the desired application, may be present in a proportion of 0% by weight to 40% by weight inclusive, in particular 0 to 20% by weight inclusive, based on the total weight of the mixture.

According to one embodiment, the resin composition has low halogen contents and thus meets IEC 61249-2-21 requirements.

According to a further embodiment, the mixture and the hardener component are present in the resin composition in a ratio to each other which is between 100:90 and 100:130 inclusive. With these mixing ratios, a good processability and a long processability of the resin composition are ensured.

According to a further embodiment, the accelerator comprises an M-carboxylic acid salt, wherein M is selected from Zn, Zr and Y. The accelerator may be present in an amount of including 2% by weight to 10% by weight, inclusive, based on the total weight of the hardener component. For example, zinc octoate L230 (Baerlocher GmbH) may be used as accelerator.

According to a further embodiment, the resin composition has a glass transition temperature Tg of greater than 150° C. In particular, after curing, the resin composition has a Tg of greater than 150° C. With such a detectable glass transition temperature, process control during processing and curing of the resin composition can be well performed. Preferably, Tg remains after up to 5 DSC runs up to 260° C. at the same level, i.e. changes at most slightly.

According to a further embodiment, the resin composition has a viscosity of less than 4000 mPas, in particular less than 2000 mPas. Thus, the resin composition can be easily processed, for example it can be easily cast.

According to a further embodiment, the resin composition has a viscosity of less than 1000 mPas for at least four hours after its mixing. “After its mixing” means after mixing of the mixture and the hardener component. The resulting chemical cross-linking reaction does not lead to such a high increase in viscosity for at least four hours such that the viscosity exceeds 1000 mPas, so that the resin composition can be well moulded and cast for at least 4 h.

Further, the use of the resin composition for the manufacture of a component of an optoelectronic device is provided. All features mentioned in connection with the resin composition thus also apply to the use and vice versa.

The component may be, for example, a potting, a sub-potting, a coating, a conversion layer, a reflection layer, an optical filter, a lens or a housing. In that such a component is manufactured with a resin composition according to the above embodiments, the component has a functional material with a high temperature stability as well as a high mechanical stability. This leads to an improvement of the performance and lifetime of the optoelectronic device, for example an LED.

An optoelectronic device is further provided which comprises at least one component comprising a cured resin composition according to one of the above embodiments. All features mentioned in connection with the resin composition thus also apply to the device and vice versa.

The component may be, for example, a potting, a sub-potting, a coating, a conversion layer, a reflection layer, an optical filter, a lens or a housing. The component thus contains a functional material made of the resin composition, which has a high mechanical and temperature stability and thus favours life time and stability of the component.

A method of manufacturing an optoelectronic device comprising a component prepared by applying and curing the resin composition according to any of the above embodiments is further provided. All of the features mentioned in conjunction with the resin composition and the optoelectronic device also apply to the method and vice versa.

Due to the aforementioned properties of the resin composition, it can be applied particularly well, in particular cast, the curing can be controlled well by means of controlling the glass transition temperature and a component can be produced which a temperature-stable functional material that is at least largely free of cracks.

According to one embodiment, applying the resin composition comprises a method selected from casting, dispensing, jetting, spraying, stamping and printing. These methods are particularly easy to apply because the resin composition is liquid.

The hardener component present in the resin composition allows fast and bubble-free processing by in-line reel-to-reel technology, for example within 3 to 10 min in the temperature range of 160 to 190° C. The most complete curing possible can then take place within 2 to 6 hours at temperatures between 150° C. and 160° C.

Furthermore, with these hardener components it is possible, for example, to start curing strip-shaped processing variants or modules within 30 to 60 minutes at temperatures between 120 and 140° C. in a stand-alone oven. Curing can then take place as explained above.

Further advantageous embodiments and further developments are shown in the exemplary embodiments described below in connection with the figures.

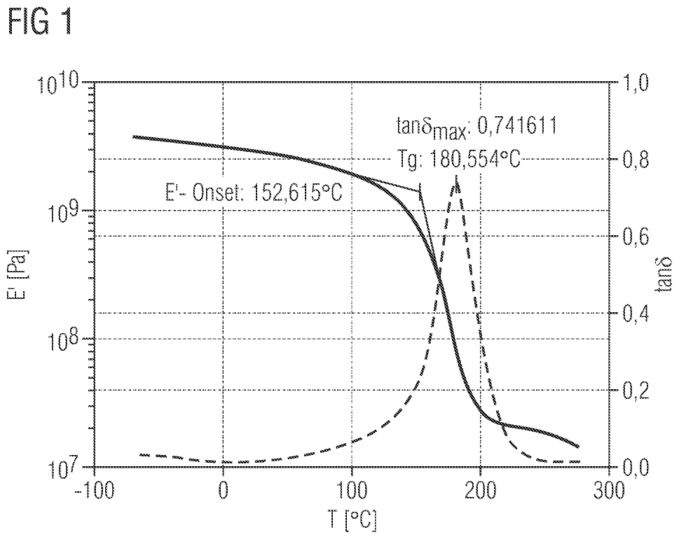

FIG. 1 shows a DMA measurement of a functional material made from an exemplary embodiment of the resin composition.

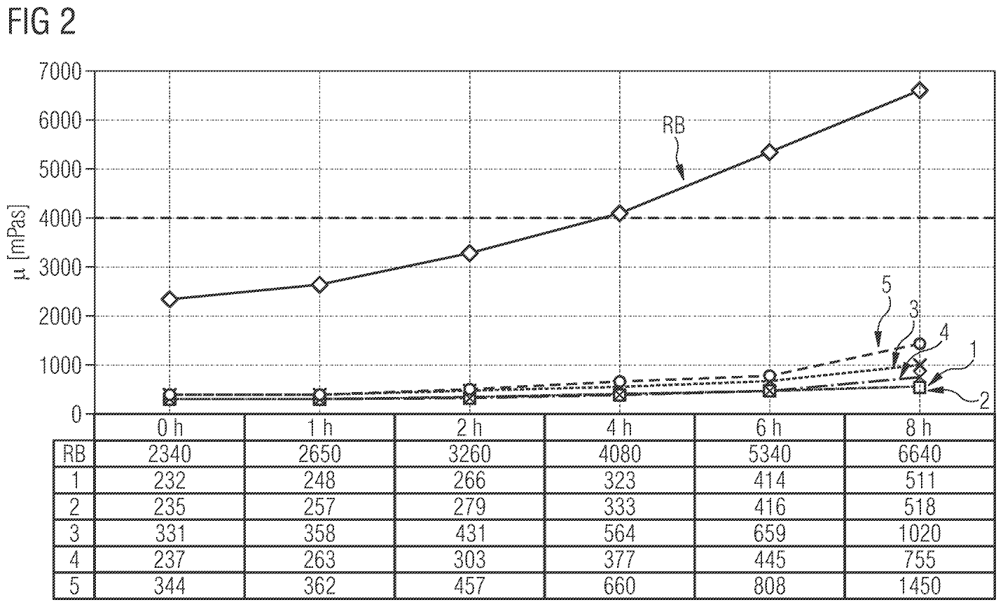

FIG. 2 shows a plot of viscosity versus time for various exemplary embodiments and a reference example,

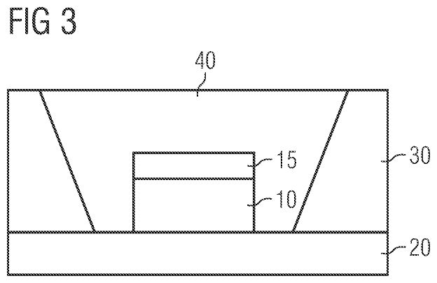

FIG. 3 shows a schematic cross-section of an optoelectronic device.

Elements that are identical, similar or have the same effect have the same reference signs in the figures. The figures and the proportions of the elements shown in the figures are not to be regarded as true to scale. Rather, individual elements may be shown exaggeratedly large for better representability and/or understanding.

The following table shows exemplary embodiments 1 to 5 of resin compositions and their respective components:

TABLE 1

| | Resin composition | | | | |
|---|---|---|---|---|---|
| | 1 | 2 | 3 | 4 | 5 |
| Mixture | | | | | |
| Cycloaliphatic | 93.985 | 93.985 | 93.985 | | |
| epoxy resin (CY179- | | | | | |
| 1 CH) | | | | | |
| [% by weight] | | | | | |
| Cycloaliphatic | | | | 93.985 | 93.985 |
| epoxy resin | | | | | |
| (Celloxide 2021 P) | | | | | |
| [% by weight] | | | | | |
| Epoxy-containing | 5.0 | 5.0 | | 5.0 | |
| compound (DY-E/CH) | | | | | |
| [% by weight] | | | | | |
| Polycarbonate diol | | | 5.0 | | 5.0 |
| (Placell CD220 EC) | | | | | |
| [% by weight] | | | | | |
| Coupling agent | 0.7 | 0.7 | 0.7 | 0.7 | 0.7 |
| [% by weight] | | | | | |
| Deaerator | 0.3 | 0.3 | 0.3 | 0.3 | 0.3 |
| [% by weight] | | | | | |
| Optical brightener | 0.015 | 0.015 | 0.015 | 0.015 | 0.015 |
| [Gew %] | | | | | |
| Hardener component | B18 | B18 | B18 | B18 | B18 |
| Mixture ratio | 100:110 | 100:120 | 100:110 | 100:110 | 100:110 |
| Mixture:hardener | | | | | |
| component | | | | | |

CY179-1CH and Celloxide 2021 P have the same epoxy resin with CAS 286-87-0 and differ in the epoxy resin content, purity and any by-products. The hardener component B18 contains a methyl hexahydrophthalic anhydride, an anhydride semi ester, Irgafos TPP and zinc octoate L230.

The mixtures of exemplary embodiments 1 to 3 thus contain a different cycloaliphatic epoxy resin than those of exemplary embodiments 4 and 5. Furthermore, the mixtures of exemplary embodiments 1, 2 and 4 contain a reactive diluent, whereas the mixtures of embodiments 3 and 5 contain a polycarbonate diol. All exemplary embodiments further contain a silane coupling agent, a deaerator and an optical brightener.

By using the indicated hardener component, technical risks and costs can be minimized. A hardener component based on methylhexahydrophthalic anhydride further contains an acidic semi ester, an organic phosphite and zinc octoate as an accelerator. By modifying with the semi ester, particularly crack-resistant functional material structures can be obtained.

Alternatively, it is conceivable to use the analogous hardener component on hexahydrophthalic anhydride base. With both hardener components, casting processes in reel-to-reel technology or the processing of leadframe strips in stand-alone curing ovens can be used.

The exemplary embodiments 1 to 5 are compared below with a reference example RB, which is a commercially available cycloaliphatic epoxy resin for LED potting.

The following Table 2 shows the thermoanalytical characteristics of the functional materials obtained from the exemplary embodiments, which were obtained by curing the respective resin composition (the numbering refers to the respective resin composition, i.e. F1 is the functional material obtained from the resin composition 1, and so on, FRB is the reference functional material).

TABLE 2

| | Functional material | | | | | |
|---|---|---|---|---|---|---|
| | FRB | F1 | F2 | F3 | F4 | F5 |
| Thermomechanical | | | | | | |
| analysis | | | | | | |
| CTE1 [ppm/K] | 57 | 69 | 70 | 67 | 68 | 70 |
| CTE2 [ppm/K] | 182 | 195 | 195 | 204 | 198 | 185 |
| Dynamical- | | | | | | |
| mechanical | | | | | | |
| analysis | | | | | | |
| Tg [° C.] | 188 | 181 | 176 | 182 | 178 | 182 |
| tanδₘₐₓ | 0.6317 | 0.7416 | 0.5591 | 0.6526 | 0.6819 | 0.6242 |
| E′ [MPa] at 20° C. | 3629 | 3006 | 2710 | 3094 | 2973 | 3009 |
| E′ [MPa] at 150° C. | 924 | 800 | 676 | 652 | 706 | 629 |
| E′-Onset [° C.] | 154 | 153 | 146 | 149 | 145 | 145 |
| Thermogravimetric | | | | | | |
| analysis | | | | | | |
| (10 K/min, air) | | | | | | |
| Loss of weight | 0.5 | 0.3 | 0.6 | 0.5 | 0.7 | 0.6 |
| at 260° C. in [%] | | | | | | |

The thermal expansion coefficients CTE1 and CTE2 were determined by thermomechanical analysis. CTE1 describes the linear thermal expansion coefficient below the glass transition temperature Tg and CTE2 correspondingly above Tg. By means of dynamic mechanical analysis, the glass transition temperature Tg, which for all samples is clearly above 150° C., as well as the mechanical damping tan δₘₐₓ, the storage modulus E′ at 20° C. and at 150° C. and the onset temperature E′-Onset are determined.

FIG. 1 shows an example for exemplary embodiment F1 of the DMA investigation. The tensile mode during the measurement was 1 Hz at 3/min. The storage modulus E′ in Pa and the mechanical damping (tan δ) are shown as a function of the temperature T in ° C. The maximum of the tan δ curve is taken as Tg (glass transition temperature). The onset temperature of the storage module E′ and the Tg provide information about the temperature application limits of the resin composition and thus the target application of the functional material obtained from the resin composition in an optoelectronic device, for example an LED encapsulated with the functional material.

FIG. 2 shows the viscosities p in mPas of exemplary embodiments 1 to 5 and the reference example RB as a function of time t in h. The viscosities were measured rheologically in a plate-cone arrangement with a diameter of 25 mm and a shear angle of 2°. The measurements were performed at 25° C. and a shear rate of 250 s⁻¹. The viscosities of exemplary embodiments 1 to 5 and of reference example RB at 0 h, 1 h, 2 h, 4 h, 6 h and 8 h are also are indicated in FIG. 2.

For applying, in particular for casting, the viscosities should be as low as possible and remain as stable as possible over a processing time of at least four hours. Thereby, the viscosity should not exceed 4000 mPas. FIG. 1 shows that the reference resin RB can only be used to a limited extent and exceeds the critical viscosity of 4000 mPas after four hours of processing. The resin compositions of exemplary embodiments 1 to 5 have significantly lower viscosities, in particular they are lower than 1000 mPas for at least 6 h and are thus usable for at least four hours. Exemplary embodiments 4 and 5, which use a different cycloaliphatic epoxy resin than the other exemplary embodiments, show a slightly higher viscosity increase than exemplary embodiments 1 to 3.

Furthermore, it must be ensured that the reactivity and the glass transition temperature Tg of the resin compositions do not change as far as possible during their use, i.e. for at least 4 h. In order to determine the service life, the resin compositions were examined by means of DSC (Dynamic Scanning calorimetry).

For this purpose, the resin compositions were cured for one hour at 130° C. in DSC crucibles and the residual reaction as well as the glass transition temperature were determined in DSC run 2 at 40K/min directly after mixing, after four hours and after six hours. Table 3 below shows that both the reactivity and the Tg change only slightly at most over the process time up to six hours. It can thus be shown that the thermomechanical properties of the cured resin compositions and thus the stability of an LED containing such a resin composition remain unchanged stable over the process time. This also applies to different resin compositions as shown by the comparison of exemplary embodiments 1 and 2.

TABLE 3

| | Resin composition | | |
|---|---|---|---|
| | 1 | 2 | 3 |
| Mixture ratio | 100:110 | 100:120 | 100:110 |
| mixture:hardener component | | | |
| Reactivity (1 hour curing at | | | |
| 130° C., residual reaction | | | |
| after mixing) [%] | | | |
| Beginning | 8.6 | 8.2 | 7.7 |
| After 4 h | 8.6 | 8.2 | 8.5 |
| After 6 h | 8.6 | 7.4 | 8.5 |
| Tg [° C.] | | | |
| Beginning | 174 | 167 | 184 |
| After 4 h | 174 | 167 | 183 |
| After 6 h | 174 | 166 | 183 |

For the reference example RB, Tg cannot be detected by DSC, even at a high heating rate of 40 K/min. On the other hand, the measurements of exemplary embodiments 1 to 3 show that their reactivity changes only slightly in a time frame of at least four hours after mixing and that the Tg obtained after curing also remains at the same level.

In order to obtain a statement on the temperature stability of the resin compositions and functional materials obtained from them, the reactive behaviour of the resin compositions was investigated by means of DSC and the Tg was compared with each other after a total of five DSC runs. The Tg determined from the third DSC run onwards was carried out at a heating rate of 40 K/min up to 260° C. in each case. The results can be seen in Table 4.

TABLE 4

| Resin composition | 1 | 2 | 3 | 4 | 4a | 5 | 5a |
|---|---|---|---|---|---|---|---|
| Mixture ratio | 100:110 | 100:120 | 100:110 | 100:110 | 100:120 | 100:110 | 100:120 |
| mixture:hardener | | | | | | | |
| component | | | | | | | |
| Tg [° C.] | | | | | | | |
| 3. run | 176 | 166 | 185 | 176 | 167 | 179 | 172 |
| 4. run | 175 | 166 | 185 | 175 | 166 | 180 | 172 |
| 5. run | | 167 | 184 | | 168 | | 169 |

The exemplary embodiments 4a and 5a differ from the exemplary embodiments 4 and 5 only by the mixing ratio mixture:hardener component.

After a total of five DSC measurements up to 260° C., no significant Tg decreases can thus be found. This points to the high thermomechanical stability of the materials, which is particularly advantageous for their use as encapsulation materials in optoelectronic devices. In addition, functional materials obtained from them enable high soldering stability in an LED package.

Furthermore, the influence of the cycloaliphatic epoxy resin used in the mixture has no significant effect on reactivity, Tg and temperature stability of the resin composition or the functional material obtained therefrom. This is shown by way of example in the following Table 5:

TABLE 5

| Resin composition | 1 | 2 | 3 | 4 | 4a | 5 | 5a |
|---|---|---|---|---|---|---|---|
| Mixture ratio | 100:110 | 100:120 | 100:110 | 100:110 | 100:120 | 100:110 | 100:120 |
| mixture:hardener | | | | | | | |
| component | | | | | | | |
| Cycloaliphatic | CY179-1 CH | | | Celloxide 2021 P (DAICEL) | | | |
| epoxy resin | (Huntsmann) | | | | | | |
| Residual reaction | 8.6 | 8.2 | 7.7 | 5.6 | 8.0 | 10.1 | 3.1 |
| [%] after one | | | | | | | |
| hour curing at | | | | | | | |
| 130° C. | | | | | | | |
| Tg [° C] (2. run | 174 | 167 | 184 | 175 | 166 | 178 | 173 |
| determined at 40 | | | | | | | |
| K/min) | | | | | | | |

Furthermore, the high yellowing stability of the resin compositions can be substantiated by functional material removals after five days at 160° C. as well as after four days of UVA irradiation with 60 mW/cm² at 90° C. The materials show similar low discolouration as the reference example RB. The materials show a similar low discolouration as the yellowing stable reference example RB.

FIG. 3 shows an example of an optoelectronic device containing at least one component made of a resin composition indicated above.

Here, an active layer sequence 10 arranged to emit electromagnetic radiation, in the optical path of which a conversion layer 15 is arranged, is disposed on a substrate 20. Furthermore, on the substrate 20 a housing 30 is present, in the recess of which the active layer sequence 10 and the conversion layer 15 are located.

Further in the recess of the housing 30, a potting 40 surrounding the active layer sequence 10 and the conversion layer 15 is present.

In this example, the potting 40 comprises a functional material produced by curing a resin composition according to one of the exemplary embodiments. Additionally or alternatively, other components of the device, for example the housing 30 or the conversion layer 15, may contain or consist of such a functional material. Additionally or alternatively, the device may also comprise other components not explicitly shown herein, for example a lens, which may comprise such a functional material.

The invention is not limited by the description based on the exemplary embodiments herein. Rather, the invention encompasses any new feature as well as any combination of features, which particularly includes any combination of features in the claims, even if this feature or combination itself is not explicitly indicated in the claims or exemplary embodiments.

### LIST OF REFERENCE SIGNS

RB Reference example
1 Resin composition according to exemplary embodiment 1
2 Resin composition according to exemplary embodiment 2
3 Resin composition according to exemplary embodiment 3
4 Resin composition according to exemplary embodiment 4
5 resin composition according to exemplary embodiment 5
10 Active layer sequence
15 Conversion layer
20 Substrate
30 Housing
40 Potting

1. A resin composition comprising a mixture containing
a cycloaliphatic epoxy resin,
a coupling agent, and
a polycarbonate alcohol or an epoxy-containing compound and
a polycarbonate alcohol, and
a hardener component comprising a dicarboxylic anhydride, a dicarboxylic anhydride semi ester, an organic phosphite, and an accelerator,
wherein the polycarbonate alcohol is a polycarbonate diol.

2. The resin composition according claim 1, wherein the cycloaliphatic epoxy resin is free of aromatic structural units.

3. The resin composition according to claim 1, wherein the coupling agent comprises an alkoxysilane.

4. The resin composition according to claim 3, wherein the alkoxysilane is a γ-glycidoxypropyltrimethoxysilane.

5. (canceled)

6. The resin composition according to claim 1, wherein the polycarbonate diol is of the general formula 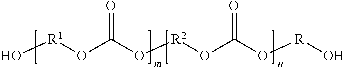
wherein R is R¹ or R² and wherein R, R¹ and R² are independently selected from a group comprising C1 to C22 alkyl groups.

7. The resin composition according to claim 1, wherein the mixture further comprises at least one additive selected from a group comprising polyvalent alcohols, deaerators, degassing agents, leveling aids, release agents, brighteners, dyes, stabilizers, antioxidants, light stabilizers, fillers, pigments, thickeners, phosphors and mixtures thereof.

8. The resin composition according to claim 1, wherein the accelerator comprises an M-carboxylic acid salt, wherein M is selected from Zn, Zr and Y.

9. The resin composition according to claim 1, wherein the mixture and the hardener component are present in a ratio to each other which is between 100:90 and 100:130 inclusive.

10. The resin composition according to claim 1, having a glass transition temperature Tg of greater than 150° C.

11. The resin composition according to claim 1, having a viscosity of less than 4000 mPas.

12. The resin composition according to claim 1, having a viscosity of less than 1000 mPas for at least 4 h after its mixing.

13. A use of the resin composition according to claim 1 for the manufacture of a component of an optoelectronic device.

14. An optoelectronic device comprising at least one component containing a cured resin composition according to claim 1.

15. A method of manufacturing an optoelectronic device comprising a component prepared by applying and curing the resin composition according to claim 1.

16. The resin composition according to claim 7, wherein fillers and pigments comprise calcium fluoride, titanium dioxide, aluminum oxide, mica, silicon dioxide, wollastonite or calcium carbonate.

17. The resin composition according to claim 7, wherein fillers and pigments are present in a proportion of from 0% by weight to 50% by weight inclusive based on the total weight of the mixture.

18. The use according to claim 13, wherein the component is a potting, a sub-potting, a coating, a conversion layer, an optical filter, or a lens.

19. The optoelectronic device according to claim 14, wherein the component is a potting, a sub-potting, a coating, a conversion layer, an optical filter, or a lens.

20. A resin composition comprising a mixture containing
a cycloaliphatic epoxy resin,
a coupling agent, and
an epoxy-containing compound and/or a polycarbonate alcohol, and
a hardener component comprising a dicarboxylic anhydride, a dicarboxylic anhydride semi ester, an organic phosphite, and an accelerator.
